(19) United States
(12) Patent Application Publication
(10) Pub. No.: US 2024/0265207 A1
(43) Pub. Date: Aug. 8, 2024

(54) TRAINING OF AN OBJECT LINKING MODEL

(71) Applicant: Microsoft Technology Licensing, LLC, Redmond, WA (US)

(72) Inventors: Dejian YANG, Redmond, WA (US); Jian-Guang LOU, Redmond, WA (US); Dongmei ZHANG, Beijing (CN)

(21) Appl. No.: 18/565,067

(22) PCT Filed: May 23, 2022
(86) PCT No.: PCT/US2022/030453

§ 371 Date: Nov. 28, 2023

(30) Foreign Application Priority Data
Jun. 25, 2021 (CN) 202110711428.7

(51) Int. Cl. G06F 40/30

(52) U.S. Cl. CPC G06F 40/30

(57) ABSTRACT

According to implementations of the present disclosure, there is provided a solution for training an object linking model. A target semantic object and a first text sequence comprising text elements in a natural language are obtained. A first confidence score of the target semantic object being mentioned in the first text sequence is determined. A second confidence score of the target semantic object being mentioned in the first text sequence is determined with a first text element being ignored from the first text sequence. An object linking model is trained at least based on a first confidence difference between the first and second confidence scores, the first text sequence and the target semantic object. In this way, the cost and difficulty in labeling a training dataset may be reduced and the labeling accuracy and efficiency may be improved.

### BACKGROUND

In human-machine interaction tasks such as semantic parsing and intelligent question answering, it is very important to link text elements in a human natural language with semantic objects (e.g., entities, processing operations and so on) stored and recognized by the machine. To ensure fast and accurate determination of the linking relationship between the text elements and the semantic objects, a normal choice is to train a machine learning model, which may be referred to as an object linking model. The model training process requires preparing a large scale of training dataset. However, labeling the dataset may consume considerable manual costs and have high difficulty, so usually the trained model may fail to meet the product requirements.

Therefore, it is desired to provide a model training solution less dependent on manual costs.

### SUMMARY

According to implementations of the subject matter described herein, there is provided a solution for training an object linking model. In the solution, a target semantic object and a text sequence in a natural language are obtained, the text sequence comprising a plurality of text elements. A first confidence score of the target semantic object being mentioned in the first text sequence is determined. A second confidence score of the target semantic object being mentioned in the first text sequence is determined with a first text element being ignored from the first text sequence. An object linking model is trained at least based on a first confidence difference between the first confidence score and the second confidence score, the first text sequence, and the target semantic object, the object linking model being configured to determine whether the target semantic object is linked to one of the plurality of text elements. In this way, the cost and difficulty in labeling a training dataset may be significantly reduced, and the labeling accuracy and efficiency may be improved.

The Summary is to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of a computing device in which various implementations of the subject matter described herein can be implemented;

FIG. 2A illustrates a schematic system of determining a second linking score in a model training process in accordance with some implementations of the subject matter described herein;

FIG. 2B illustrates a schematic system of determining a first linking score in a model training process in accordance with some implementations of the subject matter described herein;

FIG. 3 illustrates a flow chart of a process of training an object linking model in accordance with some implementations of the subject matter described herein; and

FIG. 4 illustrates a flow chart of an example process of training an object linking model in accordance with some implementations of the subject matter described herein.

Throughout the drawings, the same or similar reference symbols refer to the same or similar elements.

### DETAILED DESCRIPTION OF EMBODIMENTS

Principles of the subject matter described herein will now be described with reference to some example implementations. It is to be understood that these implementations are described only for the purpose of illustration and help those skilled in the art to better understand and thus implement the subject matter described herein, without suggesting any limitations to the scope of the subject matter disclosed herein.

As used herein, the term “includes” and its variants are to be read as open terms that mean “includes, but is not limited to.” The term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

As used herein, the term “model” may learn an association between corresponding input and output from training data, and thus a corresponding output may be generated for a given input after the training. The generation of the model may be based on machine learning techniques. Deep learning is one of machine learning algorithms that processes the input and provides the corresponding output using a plurality of layers of processing units. A neural network model is an example of a deep learning-based model. As used herein, “model” may also be referred to as “machine learning model”, “learning model”, “machine learning network” or “learning network”, which are used interchangeably herein.

A “neural network” is a machine learning network based on deep learning. The neural network can process an input to provide a corresponding output, and usually includes an input layer, an output layer, and one or more hidden layers between the input layer and the output layer. The neural network used in deep learning applications usually includes a large number of hidden layers to increase the depth of the network. The layers of the neural network are connected in order, so that the output of a preceding layer is provided as the input of a next layer, where the input layer receives the input of the neural network, and the output of the output layer is regarded as a final output of the neural network. Each layer of the neural network includes one or more nodes (also referred to as processing nodes or neurons), each of which processes input from the preceding layer.

Generally, machine learning may include three stages, i.e., a training stage, a test stage, and an application stage (also referred to as an interference stage). In the training stage, a given model may be trained using a great amount of training data, with parameter values being iteratively updated until the model can obtain, from the training data, consistent interference that meets an expected target. Through the training, the model may be considered as being capable of learning the association between the input and the output (also referred to as an input-to-output mapping) from the training data. The parameter values of the trained model are determined. In the test stage, a test input is applied to the trained model to test whether the model can provide a correct output, so as to determine the performance of the model. In the application stage, the model may be used to process an actual input based on the parameter values obtained in the training and to determine the corresponding output.

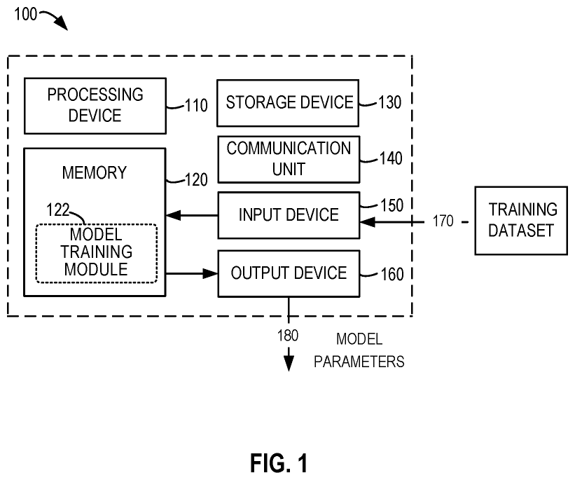

FIG. 1 illustrates a block diagram of a computing device 100 in which various implementations of the subject matter described herein can be implemented. It would be appreciated that the computing device 100 as shown in FIG. 1 is merely provided as an example, without suggesting any limitation to the functionalities and scope of implementations of the subject matter described herein. As shown in FIG. 1, the computing device 100 is in form of a general-purpose computing device. Components of the computing device 100 may include, but are not limited to, one or more processors or processing devices 110, a memory 120, a storage device 130, one or more communication units 140, one or more input devices 150, and one or more output devices 160. In some implementations, the computing device 100 may be implemented as any user terminal or server terminal with computing capability. The server terminal may be any server, large-scale computing device, and the like that is provided by a variety of service providers. The user terminal may, for example, be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, TV receiver, radio broadcast receiver, E-book device, gaming device, or any combination thereof, including the accessories and peripherals of these devices, or any combination thereof. It is also anticipated that the computing device 100 can support any type of interface to a user (such as “wearable” circuitry and the like).

The processing unit 110 can be a physical or virtual processor and may execute various processes based on the programs stored in the memory 120. In a multi-processor system, a plurality of processing units execute computer-executable instructions in parallel so as to enhance parallel processing capability of the computing device 100. The processing unit 110 may also be known as a central processing unit (CPU), a microprocessor, a controller, or a microcontroller.

The computing device 100 usually includes various computer storage medium. The computer storage medium may be any available medium accessible by the computing device 100, including but not limited to, volatile and non-volatile medium, or detachable and non-detachable medium. The memory 120 may be a volatile memory (for example, a register, cache, Random Access Memory (RAM)), non-volatile memory (for example, a Read-Only Memory (ROM), Electrically Erasable Programmable Read-Only Memory (EEPROM), or any combination thereof. The storage device 130 may be any detachable or non-detachable medium and may include machine-readable medium such as a memory, a flash memory drive, a magnetic disk or any other medium that can be used for storing information and/or data and are accessible by the computing device 100.

The computing device 100 may further include additional detachable/non-detachable, volatile/non-volatile memory medium. Although not shown in FIG. 1, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 140 implements communication with another computing device via the communication medium. In addition, the functionalities of components in the computing device 100 may be implemented by a single computing cluster or a plurality of computing machines that can communicate with each other via communication connections. Thus, the computing device 100 may operate in a networked environment using a logic connection with one or more other servers, network personal computers (PCs), or further general network nodes.

The input device 150 may include one or more of a variety of input devices, such as a mouse, keyboard, tracking ball, voice-input device, and the like. The output device 160 may include one or more of a variety of output devices, such as a display, loudspeaker, printer, and the like. By means of the communication unit 140, the computing device 100 may further communicate with one or more external devices (not shown) such as storage devices and display devices, one or more devices that enable the user to interact with the computing device 100, or any devices (such as a network card, a modem and the like) that enable the computing device 100 to communicate with one or more other computing devices, if required. Such communication may be performed via input/output (I/O) interfaces (not shown).

In some implementations, as an alternative of being integrated on a single device, some or all components of the computing device 100 may also be arranged in the form of cloud computing architecture. In the cloud computing architecture, the components may be provided remotely and work together to implement the functionalities described in the subject matter described herein. In some implementations, cloud computing provides computing, software, data access and storage service, which will not require end users to be aware of the physical locations or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The computing device 100 may be used to implement model training in accordance with various implementations of the subject matter described herein. The memory 120 may include one or more modules having one or more program instructions. These modules may be accessed and run by the processing unit 110 to perform functions of various implementations described herein. For example, the memory 120 may include a model training module 122 for performing training operations on an object linking model. The computing device 100 may be used to implement model training in various implementations of the subject matter described herein. As shown in FIG. 1, the computing device 100 may receive a dataset 170 for model training via the input device 150. The computing device 100, e.g., the model training module 122 in the computing device 100, may automatically train the object linking model using the training dataset 170 until model parameters converge. The computing device 100 may also provide the model parameters 180 obtained through training.

Although in the example of FIG. 1, the computing device 100 receives the training dataset 170 from the input device 150 and provides the model parameters 180 via the output device 160, this is only illustrative and not intended to limit the scope of the subject matter described herein. The computing device 100 may also receive the training dataset 170 from other devices (not shown) via the communication unit 140 and/or provide the model parameters 180 externally via the communication unit 140.

Herein, the object linking model is trained to determine the linking between respective text elements in a natural language and machine-recognizable semantic objects, so as to provide accurate data for subsequent processing tasks such as semantic parsing. A semantic object is sometimes referred to as a logical concept, a semantic perception, a semantic concept, and the like. The linking between a text element and a semantic object is also referred to as grounding from the text element to the semantic object.

In the model training process, the model training module 122 can receive the training dataset 170 for training the object linking model via the input device 150. The training dataset 170 may be labeled by the user and input by the user, or obtained or received via other means such as from a public dataset. The model training module 122 is configured to perform model training based on the training dataset 170 and provide the model parameters as the output 180 when the current model parameters converge or when the number of iterations of model training exceeds a threshold number of iterations. The output 180 may optionally be output via the output device 160 for subsequent model testing and application. The embodiments of the subject matter described herein are not limited in this regard.

It should be appreciated that the components and arrangements of the computing device shown in FIG. 1 are only examples, and the computing device suitable for implementing the example implementation described in the subject matter described herein may include one or more different components, other components, and/or different arrangements. The input of the training dataset and the output of the model parameters shown in FIG. 1 are also only examples.

In order to perform the semantic parsing operation, a traditional semantic parsing approach may be based on a rule-based heuristic algorithm. This approach requires manual configuration of a high-quality dictionary and also requires manually written rules. Therefore, there exist problems such as inflexible parsing processing and excessive human resource costs. In addition, the traditional semantic parsing approach may further perform model training by preparing the training dataset as stated above. However, it is very difficult to label the dataset, and the problem of high human resource costs also exists.

As mentioned above, when performing operations such as semantic parsing and intelligent question answering, it is usually required to determine the linking relationship between text elements in a human natural language and semantic objects stored in and recognizable by the machine. Herein, a text element in the natural language may refer to a text element in a natural language text input by the user, for example, a word (in Latin languages such as in English) or a single word (in oriental languages such as in Chinese). A semantic object may depend on a specific linking task. For example, in a query task related to a data table, it is desired to determine whether text elements in a query statement in the natural language correspond to respective elements in the stored data table. In such a task, semantic objects may usually include elements in a structured data table stored in the computing device 110, such as a header, cell values, aggregate functions, symbols and the like, and processing operations to be performed for these elements, such as addition, averaging, screening, and the like. As another example, in a task related to a knowledge base, it is desired to determine whether text elements in the natural sentence correspond to entities in the knowledge base. In this example, the semantic objects may include the entities in the knowledge base maintained by the computing device 110.

For example, in a scenario of determining an answer for a user question based on information in the structured data table, a text sequence of the question input by the user is “How many total games were at braly stadium”, and the semantic objects present in the structured table are “sum”, “venue” and so on. Therefore, at least the linking between the text element “total” and the semantic object “sum” and the linking between the text element “stadium” and the semantic object “venue” are needed to be determined.

It should be appreciated that only some examples of the linking between text elements and the semantic objects are presented above. In other tasks, any other semantic objects may also be defined if required. The implementations of the subject matter described herein are not limited in this regard.

The conventional training solution for the object linking model is to manually determine which text element included in a text sequence in the training dataset is linked to which semantic object, and label the linking result. Since the text sequence in the training dataset and the semantic objects are more complicated than the above examples, there are high manual costs in manually labeling training data, and errors in data labeling.

According to implementations of the subject matter described herein, there is provided a solution for training an object linking model. In the solution, a target semantic object and a text sequence in a natural language are obtained, the text sequence comprising a plurality of text elements. A first confidence score of the target semantic object being mentioned in the first text sequence is determined. A second confidence score of the target semantic object being mentioned in the first text sequence is determined with a first text element being ignored from the first text sequence. An object linking model is trained at least based on a first confidence difference between the first confidence score and the second confidence score, the first text sequence, and the target semantic object, the object linking model being configured to determine whether the target semantic object is linked to one of the plurality of text elements. According to the above solution, only labeling whether a certain semantic object is mentioned in a corresponding text sequence is needed as supervision information for the model training, which significantly reduces the cost and difficulty in the training dataset labeling and improves the labeling accuracy and efficiency. In addition, the model training based on such supervision information can also improve the performance of the trained object linking model.

Some example implementations of the subject matter described herein will be describe in more detail with reference to the accompanying figures.

As stated briefly above, to alleviate the problem of a large workload in labeling the dataset caused in the traditional strongly-supervised model training approach, it is introduced in the subject matter described herein a weak supervising mechanism to implement the training for the object linking model. To introduce the weak supervising mechanism, an object prediction model is to be pre-trained to predict whether a specific semantic object is mentioned in a text sequence. The text sequence x={x₁, x₂, . . . , x_{N}} for training and a semantic object set C={C₁, c₂, . . . , C_{K}} are known, where N represents the number of text elements in the text sequence, and K represents the number of semantic objects in the semantic object set. With x and C known, the objective of the object prediction model is to recognize whether a semantic object cₖ in the semantic object set is mentioned in the text sequence x.

To train the object prediction model, in some implementations, supervision information 1ₖ for the semantic object cₖ in the semantic object set may be automatically obtained from downstream task data or may be manually labeled. It should be appreciated that as the supervision information only involves whether the certain semantic object is mentioned in the text sequence, the labeling difficulty is significantly reduced. In addition, the supervision information can be automatically obtained in some downstream tasks, which greatly reduce the costs for training data preparing in the model training process, and the manual labeling costs and possible errors caused by the manual labeling so that the supervision information becomes more accurate.

In some implementations, labeling information may be automatically obtained from a query task from a SQL database. Take Text-SQL is taken as an example. If the semantic object linked to the database in SQL is believed as being mentioned in a question text sequence input by the user, the supervision information 1ₖ=1; if the semantic object in the database in the SQL is believed as not being mentioned in the question text sequence, the supervision information 1ₖ=0. It is possible to determine which semantic objects are mentioned and which semantic objects are not mentioned from an SQL query statement converted from the question text sequence, so as to obtain the corresponding supervision information. The following Table 1 shows a plurality of examples of automatically obtaining the labeling information based on the SQL query statements.

TABLE 1

| Question text sequence | SQL query statement |
|---|---|
| Show name₁, country₂, age₃ for | SELECT name₁, country₂, age₃ FROM |
| all singers₄ ordered by age₃ from | singer₄ ORDER BY age₃ DESC |
| the oldest₃ to the youngest. | |
| Where is the youngest₂ teachers | SELECT hometown₁ FROM teacher₃ |
| from? | ORDER BY age₂ ASC LIMIT 1 |
| For each semester₁, what is the | SELECT semester name₂, semester |
| name₂ and id₃ of the one with | id₃ FROM semesters₁ JOIN student |
| the most students registered₄? | enrolment₄ ON semesters.semester id = |
| | student enrolment.semester id |
| | GROUP BY semester id₃ ORDER BY |
| | COUNT(*) DESC LIMIT 1 |

In Table 1, if the question text sequence is “Show name₁, country₂, age₃ for all singers₄ ordered by age₃ from the oldest₃ to the youngest.”, the corresponding SQL query statement “SELECT name₁, country₂, age₃ FROM singer₄ ORDER BY age₃ DESC” may be automatically obtained from historical query information of the SQL database (it is noted that subscripts such as numbers 1, 2, 3 and 4 in the question text sequences and the SQL query statements in Table 1 are only used to indicate the text elements and their corresponding semantic objects in the SQL database, and they are not the content of the text sequence and the SQL query statement). Since the SQL query statement includes semantic objects “name”, “country”, “age” and “singer”, it means that these semantic objects are all mentioned in the question text sequence. Accordingly, the supervision information 1ₖ for these semantic objects may be automatically determined as 1ₖ=1. Other semantic objects, such as names of other tables and columns that may be present in the SQL database, are not mentioned in the above question text sequence, and the supervision information 1ₖ of these semantic objects may be automatically determined as 1ₖ=0.

Similarly, in Table 1, if another question text sequence is “Where₁ is the youngest₂ teacher₃ from?”, the corresponding SQL query statement “SELECT hometown₁ FROM teacher₃ ORDER BY age₂ ASC LIMIT 1” may be automatically obtained from the historical query information of the SQL database. Since the SQL query statement includes semantic objects “hometown”, “age” and “teacher”, it means that these semantic objects are all mentioned in the question text sequence. Accordingly, the supervision information 1ₖ for these semantic objects may be automatically determined as 1ₖ=1. Other semantic objects that may be present in the SQL database are not mentioned in the above question text sequence, and the supervision information 1ₖ of these semantic objects may be automatically determined as 1ₖ=0.

Similarly, in Table 1, a further question text sequence is “For each semester₁, what is the name₂ and id₃ of the one with the most students registered₄?”, and the corresponding SQL query statement is “SELECT semester name₂, semester id₃ FROM semesters₁ JOIN student enrolment₄ ON semesters.semester id=student enrolment.semester id GROUP BY semester id₃ ORDER BY COUNT(*) DESC LIMIT 1”. It may be similarly determined, based on the further question text sequence and the SQL query statement, that the semantic objects “semesters”, “semester name”, “semester id” and “student enrolment” are all mentioned in the above question text sequence, so the corresponding supervision information may be automatically determined as 1ₖ=1, and the supervision information for other semantic objects may be determined as 1ₖ=0.

Through the above, the text sequences, the semantic objects and the supervision information for the semantic objects may be collected in an automatic manner

If sufficient text sequences and semantic objects and corresponding supervision information are collected, the object prediction model may be trained to perform an operation, such as a binary (mentioned or not mentioned) operation for a feature representation of each semantic object. Specifically, the object prediction model may output a confidence score of each semantic object being mentioned in the input text sequence. The text sequence and the semantic object set may all be input sequentially into a pre-trained language model (PLM) to obtain a text feature representation of each text element and an object feature representation of each semantic object. Assuming that [symbol] q₁, q₂, . . . q_{N} [symbol] represents text feature representations for the text sequence x={x₁, x₂, . . . , x_{N}}, and [symbol] e₁, e₂ . . . , e_{K} [symbol] represents an object feature representations for the sematic object set C={c₁, c₂, . . . , c_{K}}, the extraction of the feature representations by the pre-trained language model may be represented as:

$${\{ {q}_{n} \}}_{n = 1}^{N} , {\{ {e}_{k} \}}_{k = 1}^{K} = PLM ( [ CLS ] , x , {\{ [ SEP ] , {c}_{k} \}}_{k = 1}^{K} ) .$$

On the basis of the feature representations, the determination of a probability of a semantic object being mentioned in the text sequence by the object prediction model may be represented as follows:

$${p}_{k} = Sigmoid ( {W}_{l} {e}_{k} ) , \qquad ( 1 )$$

where pₖ represents a probability (referred to as a confidence score herein) of the semantic object cₖ being mentioned in the text sequence, W₁ is model parameters of the object prediction model, with parameter values being learnt in a training process, and eₖ is an object feature representation of the semantic object cₖ. Since the text sequence and the semantic objects are both input into the pre-trained language model, and the output object feature representation can characterize a feature of the semantic object with respect to the text sequence, based on which it is possible to determine whether the semantic object is mentioned in the text sequence.

Since the supervision information is sufficient, the training process of the object prediction model is simple and the costs of labeling the dataset are low, after the object prediction model with good performance has been trained, the object linking model may be further trained. The training of the object linking model may be performed on the basis of the object prediction model. It is proposed in the implementations of the subject matter described herein to perform the training of the object linking model by applying a deletion mechanism for each text element in a text sequence used for training the object linking model, and observing a difference of the confidence scores provided by the object prediction model before and after the deletion. In this way, the training of the object prediction model may be completed only on the basis of providing the weak supervision information regarding whether the semantic object(s) is mentioned in the text sequence, without the specific linking conditions between the text elements in the text sequence and the semantic object(s).

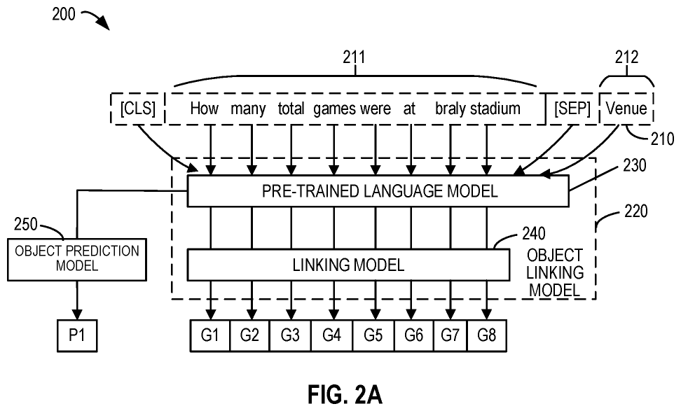

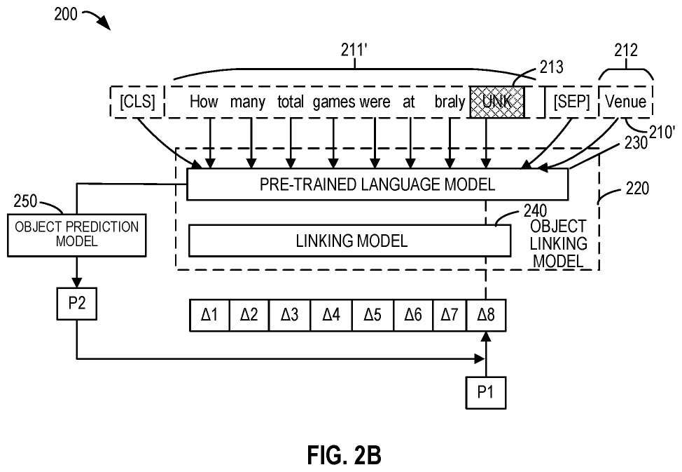

FIG. 2A and FIG. 2B illustrate partial processes of using the object prediction model to train the object linking model in the weak supervision manner. FIG. 2A illustrates a schematic system 200 for determining a linking score in a model training process in accordance with some implementations of the subject matter described herein. As shown in FIG. 2A, a sequence 210, used as the training data, is input into the object linking model 220. The sequence 210 includes a start symbol “[CLS]”, a text sequence 211, a separator “[SEP]” and a semantic object 212. The text sequence 211 includes several text elements, such as text elements “How”, “many”, “total”, “games”, “were”, “at”, “braly” and “stadium”. The semantic object 212 may be a semantic object set including a plurality of semantic objects. For the purpose of clearly illustrating the embodiment, FIG. 2A shows the case with only one semantic object “Venue”. In other examples, depending on the semantic object set under consideration, there may also be a plurality of semantic objects, and different semantic objects may be separated by a separator “[SEP]”. It should be appreciated that the input sequence given here is only an example and is not intended to limit the scope of the subject matter described herein.

In training of the object linking model 220, it is still assumed that the text sequence used for training is represented as x={x₁,x₂, . . . ,x_{N}}, the semantic object set is represented as C={c₁, c₂, . . . , c_{K}}, and a task of the object linking model 220 is to find a linking relationship between each text element in the text sequence and each semantic object in the semantic object set. Therefore, an N×K matrix is generated as the model output of the linking process. Each element in the matrix indicates a linking score between a text element and a semantic object. Since there is only one semantic object in FIG. 2A, that is, K=1, the object linking model 240 may output N linking scores (N is equal to 8 in this example because the text sequence 211 includes 8 text elements). It should be appreciated that in FIG. 2A, the linking scores G1, . . . , G8 represents linking scores between the corresponding text elements “How”, “many”, “total”, “games”, “were”, “at”, “braly” and “stadium” in the text sequence 211, and the semantic object “Venue” 212”, respectively.

As shown in FIG. 2A, the object linking model 220 includes a pre-trained language model 230 and a linking model 240. When the sequence 210 is input into the object linking model 220, the pre-trained language model 230 in the object linking model 220 may be configured to extract respective text feature representations of the plurality of text elements “How”, “many”, “total”, “games”, “were”, “at”, “braly” and “stadium” in the text sequence 211 and an object feature representation of the semantic object “Venue” 212. It should be appreciated that the pre-trained language model 230 has a self-supervised learning function. Thus, the pre-trained language model 230 and the linking model 240 may determine a linking score between each text element in the text sequence 21 and the semantic object 212. The linking score may, for example, be represented as follows:

$${g}_{n , k} = \frac{{W}_{e} {e}_{k} \cdot {( {W}_{q} {q}_{n} )}^{T}}{\sqrt{d}} \qquad ( 2 )$$

where We and Wq are both learnable parameters, and d is the number of dimensions of the object feature representation eₖ of the semantic object cₖ. Further, in some examples, the linking score may be normalized as follows:

$${α}_{n , k} = \frac{exp ( {g}_{n , k} )}{{\sum }_{i} exp ( {g}_{i , k} )} . \qquad ( 3 )$$

To provide better supervision for the linking scores, the subject matter described herein further uses the object prediction model 250 that has been trained as mentioned above to provide weak supervision information. As shown in FIG. 2A, the object prediction model 250 obtains, from the pre-trained language model 230, the plurality of text feature representations of the plurality of text elements “How”, “many”, “total”, “games”, “were”, “at”, “braly” and “stadium” in the text sequence 211 and the object feature representation of the semantic object “Venue” 212. The object prediction model 250 may determine, based on the object feature representation, a confidence score P1 of the semantic object 212 being mentioned in the text sequence 211. The processing in the target prediction model 250 is for example as shown in the above Equation (1). Since the text sequence 211 and the semantic object 212 are input into the pre-trained language model 230 together, the output object feature representation may characterize the feature of the semantic object 212 with respect to the text sequence 211. Therefore, whether the semantic object 212 is mentioned in the text sequence 211 may be determined based on the object feature representation.

Next, the text elements in the text sequence 211 will be ignored (i.e., deleted) one by one, to form new text sequences. Since the only difference between a new text sequence and the original text sequence 211 is the ignored text element, by comparing the probability of the semantic object 212 being mentioned in the new text sequence with the probability of the text sequence 211 being mentioned in the new text sequence, usually it is possible to determine that the ignored text element in the new text sequence that cases a large probability change is linked to the semantic object 212.

FIG. 2B shows an example after a certain text element is deleted in the model training process. As shown in FIG. 2B, a sequence 210′ is input into the object linking model 220. The sequence 210′ includes a start symbol “[CLS]”, a new text sequence 211′, a separator “[SEP]” and a semantic object 212. It is noted that “stadium” which is originally presented in the text sequence 211 is ignored from the new text sequence 211′. In other words, the new text sequence 211′ may be obtained by deleting the text element “stadium” from the text sequence 211. In some implementations, “stadium” may be replaced with a predetermined text symbol (for example, “[UNK]”) 213 to form the new text sequence 211′. At this time, as shown in FIG. 2B, the text elements in the new text sequence 211′ include “How”, “many”, “total”, “games”, “were”, “at”, “braly” and [UNK]”. It should be appreciated that the foregoing encoding is only an example, and is not intended to limit the scope of the subject matter described herein. The subject matter described herein may employ other encoding manners to achieve the above operation.

In order to predict whether the semantic object 212 is mentioned in the new text sequence 211′, the pre-trained language model 230 extracts text feature representations of the plurality of text elements “How”, “many”, “total”, “games”, “were”, “at”, “braly” and “[UNK]” in the text sequence 211′ and the object feature representation of the semantic object “Venue” 212. The object prediction model 250 may determine, based on the object feature representation extracted at this time, a confidence score P2 of the semantic object “Venue” 212 being mentioned in the text sequence 211′. The processing in the object prediction model 250 is for example as shown in the above Equation (1). Since the text element “stadium” is ignored, the pre-trained language model 230 does not pay attention to the feature of this text element, and thus the object feature representation of the extracted semantic object “Venue” can reflect the feature of the semantic object “Venue” with respect to the text sequence 211′ in the case where the text element “stadium” is ignored.

Accordingly, a confidence difference Δ8 in the case where the text element “stadium” is ignored may be determined by calculating the difference between P1 and P2. Similarly, the confidence differences Δ1, . . . , Δ7 for other text elements in the text sequence 211 may also be determined, as shown in FIG. 2B. A confidence difference sequence composed of the confidence differences Δ1, . . . , Δ8 may be used to supervise the training of the object linking model 220.

In some implementations, if there are a plurality of semantic objects, a confidence difference sequence may be determined for each semantic object in a similar manner. Generally speaking, a confidence difference sequence Δϵ [symbol] ^{N×K} may be determined for the text sequence x={x₁, x₂, . . . , x_{N}} and the semantic object set C={c₁, c₂, . . . , c_{K}}.

The confidence difference determined for each text element may be used to determine a probability (also referred to as the linking score) of the text element being linked to the semantic object. For example, for a certain text element, if the confidence difference is large, it means that the probability of the semantic object being mentioned in the text sequence is significantly reduced if the text element is ignored, and thus the probability of the text element being linked to the semantic object is high. In the example shown in FIG. 2B, since the text element “stadium” is linked to the semantic object “Venue”, the probability of the semantic object “Venue” being mentioned in the text sequence 211 including the text element “stadium” may be significantly greater than the probability of the semantic object “Venue” being mentioned in the new text sequence 211′ from which the text element “stadium” is ignored. In some implementations, the greater the confidence difference determined for a text element and a semantic object, the higher the probability of the text element being linked to this semantic object, that is, the greater the linking score. Otherwise, the linking score is smaller.

In some implementations, when the object linking model 220 is trained, additional weak supervision information may also be obtained for the text sequence 210, to indicate whether each semantic object in the semantic object set is mentioned in the text sequence 210. For example, if the semantic object cₖ is mentioned in the text sequence, the supervision information may be represented as 1ₖ=1; if the semantic object cₖ is not mentioned in the text sequence, the supervision information may be represented as 1ₖ=0. Similar to the supervision information used in the training of the object prediction model 250, the aforementioned supervision information may be obtained automatically from downstream task data or labeled manually. The supervision information may be used to further modify the confidence difference given by the object prediction model, thereby modifying the linking score of the text element being linked to the semantic object.

Based on the additional supervision information, the confidence difference may, for example, be represented as follows:

$${Δ}_{n , k} = {l}_{k} \cdot max ( 0 , {p}_{k} - {\hat{p}}_{n , k} ) \qquad ( 4 )$$

where Δ_{n,k} represents the confidence difference determined for the text element xₙ and the semantic object cₖ, 1ₖ is the additional supervision information for the semantic object cₖ in the semantic object set (for example, 1ₖ=0 or 1); pₖ represents a confidence score of the semantic object cₖ being mentioned in the whole text sequence, and \hat{P}_{n,k} represents a confidence score of the semantic object cₖ being mentioned in the text sequence after the text element xₙ is deleted.

According to Equation (4), if 1ₖ=0, i.e., the supervision information indicates that the semantic object cₖ is not mentioned in the text sequence, then Δ_{n,k} is determined to be 0. In the above Equation (4), through the max function, possible wrong results may also be filtered out and only the confidence difference in the case where pₖ is greater than \hat{P}_{n,k} is retained, because theoretically the confidence score given by the object prediction model 250 after a certain text element is deleted will reduce.

In some implementations, the confidence difference Δ_{n,k} adjusted by the supervision information 1ₖ in the above Equation (4) may be determined as a linking score for the text element xₙ, which linking score is determined with the assistance of the object prediction model 250. In some implementations, the linking score determined based on then confidence difference may be used as weight information to affect the training of the object linking model 220. Therefore, a training objective function of the object linking model 220 may be constructed using the linking score determined based on then confidence difference as well as the linking score determined by the object linking model 220. The training objective function may, for example, be based on a combined score of the two linking scores, represented as follows:

$${\sum }_{n} {\sum }_{k} {Δ}_{n , k} \cdot log {α}_{n , k} \qquad ( 5 )$$

where Δ_{n,k} represents the confidence difference determined for the text element xₙ and the semantic object cₖ (that is, the linking score of the text element xₙ being linked to the semantic object cₖ given by the object prediction model 250), α_{n,k} represents the linking score of the text element xₙ being linked to the semantic object cₖ determined by the object linking model 220.

In the above Equation (5), Δ_{n,k} may be used as a weight applied to the linking score α_{n,k} that is directly determined by the object linking model 220. A training objective of the object linking model 220 is to increase a weighted sum of Δ_{n,k} and α_{n,k}, for example, to maximize the above Equation (5) or to increase it to a convergence objective. During the training process, the object linking model 220 may be iteratively trained according to the above training objective function. For example, if the combined score determined based on the training objective function is decreased in one iteration, the parameters of the training objective function may be adjusted with “punishment” until the combined score determined based on the training objective function is maximized, thereby completing the training process of the object linking model 220.

It should be appreciated that the text sequences and semantic objects shown in FIG. 2A and FIG. 2B are only specific examples provided for the purpose of illustration, and any other text sequences and semantic objects are also feasible. In the training process of the object linking model, to achieve the convergence objective, a certain number of text sequences may be collected as training data, and the training may be carried out for a specific semantic object set. These are well-known to those skilled in the art and will not be elaborated any more here.

According to the implementations of the subject matter described herein, an object prediction model may be trained on the basis of weak supervision information indicating whether a semantic object is presented in text training and used to assist in training a desired object linking model, which can avoid to require precise supervision information of the linking between the text elements and the semantic objects needed in directly training the linking model. As a result, the cost of labeling training data may be reduced, and the performance of the trained object linking model may be improved.

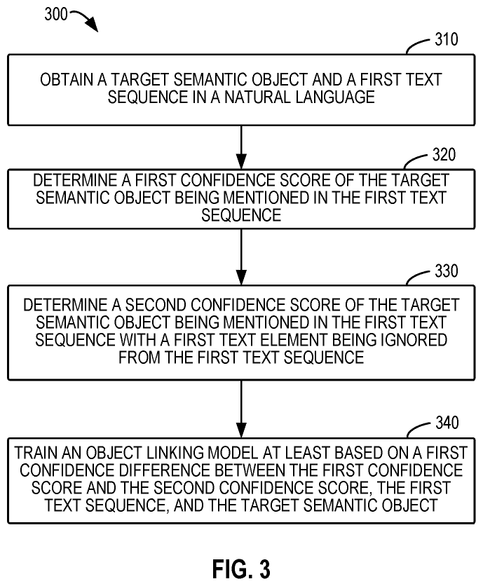

FIG. 3 illustrates a flow chart of a process 300 of training an object linking model in accordance with some implementations of the subject matter described herein. The process 300 may be implemented at the computing device 100, for example at the model training module 122, to determine the model parameters 180 based on the weakly supervised training dataset 170. For ease of discussion, the process 300 will be described with reference to FIG. 2A and FIG. 2B.

At block 310, the computing device 100 may obtain a target semantic object and a first text sequence in a natural language. The first text sequence includes a plurality of text elements.

In FIG. 2A, the example first text sequence 211 may include the text elements “How”, “many”, “total”, “games”, “were”, “at”, “braly” and “stadium”, and the example semantic object 212 may include “Venue”. It should be appreciated that the text elements and semantic objects described in FIG. 2A are exemplary, and the text elements may be words (in Latin languages such as in English) or single words (in Oriental languages such as in Chinese) in any human language. The semantic object 212 may be any machine-recognizable data linked to a natural language, and it may also be an entity in the knowledge base maintained by the computing device 110, or an element in a structured table stored in the computing device 110, such as a header, a cell value, an aggregate function, a symbol, and the like.

At block 320, the computing device 100 may determine, using the object prediction model, a first confidence score of the target semantic object being mentioned in the first text sequence.

In some example implementations, to determine the first confidence score, the computing device 100 may, using a pre-trained language model (PLM) 230, extract a plurality of text feature representations of the text elements “How”, “many”, “total”, “games”, “were”, “at”, “braly” and “stadium” and an object feature representation of the semantic object, the PLM being included in the object linking model 220. Then, the computing device 100 may determine the first confidence score using the object prediction model 240 based on the object feature representation.

At block 330, the computing device 100 may determine a second confidence score of the target semantic object being mentioned in the first text sequence, with the first text element being ignored from the first text sequence.

For example, in the example of FIG. 2B, to determine the second confidence score for the text element “stadium”, the text element “stadium” may be replaced with a predetermined text symbol “[JUNK]”, and then the text elements ““How”, “many”, “total”, “games”, “were”, “at”, “braly” other than the text element “stadium” in the plurality of text elements, the predetermined text symbol “[UNK]” and the semantic object 212 are input into the pre-trained language model 230 to extract corresponding feature representations. The object feature representation of the semantic object 212 extracted at this time is input to the object prediction model 210 to determine the second confidence score of the target semantic object being mentioned in the text sequence 211′, from which the text element “stadium” is ignored.

At block 340, the computing device 100 may train the object linking model based on at least a first confidence difference between the first confidence score and the second confidence score, the first text sequence, and the target semantic object. The object linking model is configured to determine whether the target semantic object is linked to one of the plurality of text elements in the first text sequence.

In some example implementations, the computing device 100 may use the trained object prediction model to determine the first confidence score and the second confidence score, respectively, and the computing device 100 may further obtain training data for the object prediction model, and train the object prediction model based on the training data. As an example, the training data includes a second text sequence, a semantic object, and supervision information for the semantic object indicating whether the semantic object is mentioned in the second text sequence. The text sequence, the semantic object and supervision information for training the object prediction model may be the same or different from the text sequence, the semantic object and supervision information for training the object linking model.

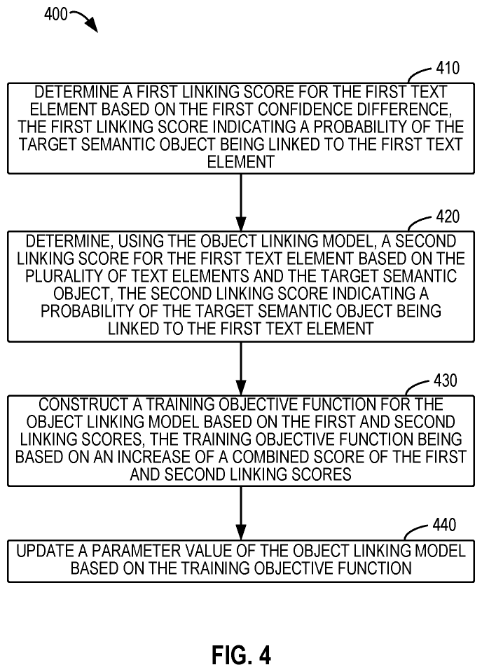

In order to illustrate the training process of the object linking model in more detail, an example training manner of the object linking model will now be discussed with reference to FIG. 4. FIG. 4 illustrates a flow chart of an example process 400 of training an object linking model in accordance with some implementations of the subject matter described herein. The process 400 may be implemented at the computing device 100, for example at the model training module 122, to determine the model parameter 180 based on the weakly supervised training dataset 170. For purpose of discussion, the process 400 will be described with reference to FIG. 2A and FIG. 2B.

At block 410, the computing device 100 determines a first linking score for the first text element (for example, “stadium”) based on the first confidence difference. The first linking score indicates a probability that the target semantic object (for example, the semantic object 212 “Venue”) is linked to the text element (for example, “stadium”).

In some example implementations, to determine the first linking score, the computing device 100 may first obtain the supervision information for the target semantic object. The supervision information for the target semantic object is used to indicate whether the target semantic object is mentioned in the first text sequence or not. For example, additional supervision data 1ₖ for the semantic object cₖ in the semantic object set may be obtained from downstream task data or labeled manually, and 1ₖ may be labeled as 0 or 1 to indicate that the semantic object is not mentioned or mentioned. The computing device 100 may perform the determination. In accordance with a determination that the supervision information for the target semantic object indicates that the target semantic object is mentioned in the first text sequence, the first linking score may be calculated based on the first confidence difference. In addition, in accordance with a determination that the supervision information for the target semantic object indicates that the target semantic object is not mentioned in the first text sequence, the first linking score may be determined to indicate that the target semantic object is not linked to the first text element. For example, the linking score based on the confidence difference is determined through the above Equation (4).

At block 420, the computing device 100 determines, using the object linking model, a second linking score for the first text element based on the first text sequence (for example, the text sequence 211 including all the text elements “How”, “many”, “total”, “games”, “were”, “at”, “braly” and “stadium”) and the target semantic object (for example, “Venue”). The second linking score is used to indicate a probability that the target semantic object is linked to the first text element.

At block 430, the computing device 100 constructs a training objective function for the object linking model based on the first and second linking scores, the training objective function being based on an increase of a combined score of the first and second linking scores. At block 440, the computing device 100 updates a parameter value of the object linking model based on the training objective function.

It should be appreciated that the computing device 100 may need to iteratively determine a linking result of the target semantic object being linked to each of the text elements. As an example, the computing device 100 may be further configured to determine a third confidence score of the target semantic object being mentioned in the updated first text sequence with another text element (e.g., the text element “braly” in the text sequence 211 in FIG. 2A) being ignored from the first text sequence, and train the object linking model further based on a second confidence difference between the first confidence score and the third confidence score.

In some example implementations, the computing device 100 may determine a linking score for training for the second text element in a similar manner to the first text element. Specifically, the computing device 100 may determine a third linking score for a further text element (for example, “braly”) based on the second confidence difference, where the third linking score indicates a probability that the target semantic object is linked to the further text element. The computing device 100 may determine, using the object linking model, a fourth linking score for the further text element based on the first text sequence including all the text elements and the semantic object, the fourth linking score indicating a probability that the target semantic object is linked to the further text element. The computing device 100 may then construct the training objective function for the object linking model 220 based on the third linking score and the fourth linking score, where the training objective function is based on an increase of a combined score of the third and fourth linking scores. In addition, the computing device 100 may update the parameter values of the object linking model 220 based on the training objective function.

Some example implementations of the subject matter described herein are listed below:
In an aspect, the subject matter described herein provides a computer-implemented method. The method comprises: obtaining a target semantic object and a first text sequence in a natural language, the first text sequence comprising a plurality of text elements; determining a first confidence score of the target semantic object being mentioned in the first text sequence; determining a second confidence score of the target semantic object being mentioned in the first text sequence with a first text element being ignored from the first text sequence; and training an object linking model at least based on a first confidence difference between the first confidence score and the second confidence score, the first text sequence, and the target semantic object, the object linking model being configured to determine whether the target semantic object is linked to one of the plurality of text elements.

In some example implementations, a trained object prediction model is used to determine the first confidence score and the second confidence score, respectively, the method further comprising: obtaining training data for the object prediction model, the training data comprising a second text sequence, a semantic object, and supervision information for the semantic object indicating whether the semantic object is mentioned in the second text sequence; and training the object prediction model based on the training data.

In some example implementations, training the object linking model comprises:
determining a first linking score for the first text element based on the first confidence difference, the first linking score indicating a probability of the target semantic object being linked to the first text element; determining, using the object linking model, a second linking score for the first text element based on the first text sequence and the target semantic object, the second linking score indicating a probability of the target semantic object being linked to the first text element; constructing a training objective function for the object linking model based on the first and second linking scores, the training objective function being based on an increase of a combined score of the first and second linking scores; and updating a parameter value of the object linking model based on the training objective function.

In some example implementations, determining the first linking score comprises: obtaining the supervision information for the target semantic object indicating whether the target semantic object is mentioned in the first text sequence; in accordance with a determination that the supervision information for the target semantic object indicates that the target semantic object is mentioned in the first text sequence, calculating the first linking score based on the first confidence difference; and in accordance with a determination that the supervision information for the target semantic object indicates that the target semantic object is not mentioned in the first text sequence, determining the first linking score to indicate that the target semantic object is not linked to the first text element.

In some example implementations, training the object linking model comprises:
determining a third confidence score of the target semantic object being mentioned in the first text sequence with a second text element ignored from the first text sequence; and training the object linking model further based on a second confidence difference between the first confidence score and the third confidence score.

In some example implementations, training the object linking model further based on the second confidence difference comprises: determining a third linking score for the second text element based on the second confidence difference, the third linking score indicating a probability of the target semantic object being linked to the second text element; determining, using the object linking model, a fourth linking score for the second text element based on the first text sequence and the target semantic object, the fourth linking score indicating a probability of the target semantic object being linked to the second text element; constructing a training objective function for the object linking model based on the third and fourth linking scores, the training objective function being based on an increase of a combined score of the third and fourth linking scores; and updating a parameter value of the object linking model based on the training objective function.

In some example implementations, determining the second confidence score comprises: replacing the first text element with a predetermined text symbol; and determining the second confidence score based on text elements among the plurality of text elements other than the first text element, the predetermined text symbol, and the target semantic object. In some example implementations, determining the first confidence score comprises: extracting, using a pre-trained language model (PLM), a plurality of text feature representations of the plurality of text elements and a first object feature representation of the target semantic object, the PLM being included in the object linking model; and determining the first confidence score based on the first object feature representation, and wherein determining the second confidence score comprises: extracting, using the PLM, text feature representations of text elements among the plurality of text elements other than the first text element and a second object feature representation of the target semantic object; and determining the second confidence score based on the second object feature representation.

In another aspect, the subject matter described herein provides an electronic device. The electronic device comprises: a processor; and a memory coupled to the processor and having instructions stored thereon, the instructions, when executed by the processor, causing the device to perform acts comprising: obtaining a target semantic object and a first text sequence in a natural language, the first text sequence comprising a plurality of text elements; determining a first confidence score of the target semantic object being mentioned in the first text sequence; determining a second confidence score of the target semantic object being mentioned in the first text sequence with a first text element being ignored from the first text sequence; and training an object linking model at least based on a first confidence difference between the first confidence score and the second confidence score, the first text sequence, and the target semantic object, the object linking model being configured to determine whether the target semantic object is linked to one of the plurality of text elements.

In some example implementations, a trained object prediction model is used to determine the first confidence score and the second confidence score, respectively, the method further comprising: obtaining training data for the object prediction model, the training data comprising a second text sequence, a semantic object, and supervision information for the semantic object indicating whether the semantic object is mentioned in the second text sequence; and training the object prediction model based on the training data.

In some example implementations, training the object linking model comprises:
determining a first linking score for the first text element based on the first confidence difference, the first linking score indicating a probability of the target semantic object being linked to the first text element; determining, using the object linking model, a second linking score for the first text element based on the first text sequence and the target semantic object, the second linking score indicating a probability of the target semantic object being linked to the first text element; constructing a training objective function for the object linking model based on the first and second linking scores, the training objective function being based on an increase of a combined score of the first and second linking scores; and updating a parameter value of the object linking model based on the training objective function.

In some example implementations, determining the first linking score comprises: obtaining the supervision information for the target semantic object indicating whether the target semantic object is mentioned in the first text sequence; in accordance with a determination that the supervision information for the target semantic object indicates that the target semantic object is mentioned in the first text sequence, calculating the first linking score based on the first confidence difference; and in accordance with a determination that the supervision information for the target semantic object indicates that the target semantic object is not mentioned in the first text sequence, determining the first linking score to indicate that the target semantic object is not linked to the first text element.

In some example implementations, training the object linking model comprises:
determining a third confidence score of the target semantic object being mentioned in the first text sequence with a second text element ignored from the first text sequence; and training the object linking model further based on a second confidence difference between the first confidence score and the third confidence score.

In some example implementations, training the object linking model further based on the second confidence difference comprises: determining a third linking score for the second text element based on the second confidence difference, the third linking score indicating a probability of the target semantic object being linked to the second text element; determining, using the object linking model, a fourth linking score for the second text element based on the first text sequence and the target semantic object, the fourth linking score indicating a probability of the target semantic object being linked to the second text element; constructing a training objective function for the object linking model based on the third and fourth linking scores, the training objective function being based on an increase of a combined score of the third and fourth linking scores; and updating a parameter value of the object linking model based on the training objective function.

In some example implementations, determining the second confidence score comprises: replacing the first text element with a predetermined text symbol; and determining the second confidence score based on text elements among the plurality of text elements other than the first text element, the predetermined text symbol, and the target semantic object.

In some example implementations, determining the first confidence score comprises: extracting, using a pre-trained language model (PLM), a plurality of text feature representations of the plurality of text elements and a first object feature representation of the target semantic object, the PLM being included in the object linking model; and determining the first confidence score based on the first object feature representation, and wherein determining the second confidence score comprises: extracting, using the PLM, text feature representations of text elements among the plurality of text elements other than the first text element and a second object feature representation of the target semantic object; and determining the second confidence score based on the second object feature representation.

In a further aspect, the subject matter described herein provides a computer program product being tangibly stored in a computer storage medium and comprising computer-executable instructions, the computer-executable instructions, when executed by a device, causing the device to perform acts comprising: obtaining a target semantic object and a first text sequence in a natural language, the first text sequence comprising a plurality of text elements; determining a first confidence score of the target semantic object being mentioned in the first text sequence; determining a second confidence score of the target semantic object being mentioned in the first text sequence with a first text element being ignored from the first text sequence; and training an object linking model at least based on a first confidence difference between the first confidence score and the second confidence score, the first text sequence, and the target semantic object, the object linking model being configured to determine whether the target semantic object is linked to one of the plurality of text elements.

In some example implementations, a trained object prediction model is used to determine the first confidence score and the second confidence score, respectively, the method further comprising: obtaining training data for the object prediction model, the training data comprising a second text sequence, a semantic object, and supervision information for the semantic object indicating whether the semantic object is mentioned in the second text sequence; and training the object prediction model based on the training data.

In some example implementations, training the object linking model comprises:
determining a first linking score for the first text element based on the first confidence difference, the first linking score indicating a probability of the target semantic object being linked to the first text element; determining, using the object linking model, a second linking score for the first text element based on the first text sequence and the target semantic object, the second linking score indicating a probability of the target semantic object being linked to the first text element; constructing a training objective function for the object linking model based on the first and second linking scores, the training objective function being based on an increase of a combined score of the first and second linking scores; and updating a parameter value of the object linking model based on the training objective function.

In some example implementations, determining the first linking score comprises: obtaining the supervision information for the target semantic object indicating whether the target semantic object is mentioned in the first text sequence; in accordance with a determination that the supervision information for the target semantic object indicates that the target semantic object is mentioned in the first text sequence, calculating the first linking score based on the first confidence difference; and in accordance with a determination that the supervision information for the target semantic object indicates that the target semantic object is not mentioned in the first text sequence, determining the first linking score to indicate that the target semantic object is not linked to the first text element.

In some example implementations, training the object linking model comprises:
determining a third confidence score of the target semantic object being mentioned in the first text sequence with a second text element ignored from the first text sequence; and training the object linking model further based on a second confidence difference between the first confidence score and the third confidence score.

In some example implementations, training the object linking model further based on the second confidence difference comprises: determining a third linking score for the second text element based on the second confidence difference, the third linking score indicating a probability of the target semantic object being linked to the second text element; determining, using the object linking model, a fourth linking score for the second text element based on the first text sequence and the target semantic object, the fourth linking score indicating a probability of the target semantic object being linked to the second text element; constructing a training objective function for the object linking model based on the third and fourth linking scores, the training objective function being based on an increase of a combined score of the third and fourth linking scores; and updating a parameter value of the object linking model based on the training objective function.

In some example implementations, determining the second confidence score comprises: replacing the first text element with a predetermined text symbol; and determining the second confidence score based on text elements among the plurality of text elements other than the first text element, the predetermined text symbol, and the target semantic object.

In some example implementations, determining the first confidence score comprises: extracting, using a pre-trained language model (PLM), a plurality of text feature representations of the plurality of text elements and a first object feature representation of the target semantic object, the PLM being included in the object linking model; and determining the first confidence score based on the first object feature representation, and wherein determining the second confidence score comprises: extracting, using the PLM, text feature representations of text elements among the plurality of text elements other than the first text element and a second object feature representation of the target semantic object; and determining the second confidence score based on the second object feature representation.

In a further aspect, the subject matter described herein provides a computer readable medium having computer-executable instructions stored thereon, the computer-executable instructions, when executed by a device, causing the device to perform the method in the above aspect.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method comprising:
obtaining a target semantic object and a first text sequence in a natural language, the first text sequence comprising a plurality of text elements;
determining a first confidence score of the target semantic object being mentioned in the first text sequence;
determining a second confidence score of the target semantic object being mentioned in the first text sequence with a first text element being ignored from the first text sequence; and
training an object linking model at least based on a first confidence difference between the first confidence score and the second confidence score, the first text sequence, and the target semantic object, the object linking model being configured to determine whether the target semantic object is linked to one of the plurality of text elements.

2. The method of claim 1, wherein a trained object prediction model is used to determine the first confidence score and the second confidence score, respectively, the method further comprising:
obtaining training data for the object prediction model, the training data comprising a second text sequence, a semantic object, and supervision information for the semantic object indicating whether the semantic object is mentioned in the second text sequence; and
training the object prediction model based on the training data.

3. The method of claim 1, wherein training the object linking model comprises:
determining a first linking score for the first text element based on the first confidence difference, the first linking score indicating a probability of the target semantic object being linked to the first text element;
determining, using the object linking model, a second linking score for the first text element based on the first text sequence and the target semantic object, the second linking score indicating a probability of the target semantic object being linked to the first text element;
constructing a training objective function for the object linking model based on the first and second linking scores, the training objective function being based on an increase of a combined score of the first and second linking scores; and
updating a parameter value of the object linking model based on the training objective function.

4. The method of claim 3, wherein determining the first linking score comprises:
obtaining the supervision information for the target semantic object indicating whether the target semantic object is mentioned in the first text sequence;
in accordance with a determination that the supervision information for the target semantic object indicates that the target semantic object is mentioned in the first text sequence, calculating the first linking score based on the first confidence difference; and
in accordance with a determination that the supervision information for the target semantic object indicates that the target semantic object is not mentioned in the first text sequence, determining the first linking score to indicate that the target semantic object is not linked to the first text element.

5. The method of claim 1, wherein training the object linking model comprises:
determining a third confidence score of the target semantic object being mentioned in the first text sequence with a second text element ignored from the first text sequence; and
training the object linking model further based on a second confidence difference between the first confidence score and the third confidence score.

6. The method of claim 5, wherein training the object linking model further based on the second confidence difference comprises:
determining a third linking score for the second text element based on the second confidence difference, the third linking score indicating a probability of the target semantic object being linked to the second text element;
determining, using the object linking model, a fourth linking score for the second text element based on the first text sequence and the target semantic object, the fourth linking score indicating a probability of the target semantic object being linked to the second text element;
constructing a training objective function for the object linking model based on the third and fourth linking scores, the training objective function being based on an increase of a combined score of the third and fourth linking scores; and
updating a parameter value of the object linking model based on the training objective function.

7. The method of claim 1, wherein determining the second confidence score comprises:
replacing the first text element with a predetermined text symbol; and
determining the second confidence score based on text elements among the plurality of text elements other than the first text element, the predetermined text symbol, and the target semantic object.

8. The method of claim 1, wherein determining the first confidence score comprises:
extracting, using a pre-trained language model (PLM), a plurality of text feature representations of the plurality of text elements and a first object feature representation of the target semantic object, the PLM being included in the object linking model; and
determining the first confidence score based on the first object feature representation, and
wherein determining the second confidence score comprises:
extracting, using the PLM, text feature representations of text elements among the plurality of text elements other than the first text element and a second object feature representation of the target semantic object; and
determining the second confidence score based on the second object feature representation.

9. An electronic device, comprising:
a processor; and
a memory coupled to the processor and having instructions stored thereon, the instructions, when executed by the processor, causing the device to perform acts comprising:
obtaining a target semantic object and a first text sequence in a natural language, the first text sequence comprising a plurality of text elements;
determining a first confidence score of the target semantic object being mentioned in the first text sequence;
determining a second confidence score of the target semantic object being mentioned in the first text sequence with a first text element being ignored from the first text sequence; and
training an object linking model at least based on a first confidence difference between the first confidence score and the second confidence score, the first text sequence, and the target semantic object, the object linking model being configured to determine whether the target semantic object is linked to one of the plurality of text elements.

10. The device of claim 9, wherein a trained object prediction model is used to determine the first confidence score and the second confidence score, respectively, the acts further comprising:
obtaining training data for the object prediction model, the training data comprising a second text sequence, a semantic object, and supervision information for the semantic object indicating whether the semantic object is mentioned in the second text sequence; and
training the object prediction model based on the training data.

11. The device of claim 9, wherein training the object linking model comprises:
determining a first linking score for the first text element based on the first confidence difference, the first linking score indicating a probability of the target semantic object being linked to the first text element;
determining, using the object linking model, a second linking score for the first text element based on the first text sequence and the target semantic object, the second linking score indicating a probability of the target semantic object being linked to the first text element;
constructing a training objective function for the object linking model based on the first and second linking scores, the training objective function being based on an increase of a combined score of the first and second linking scores; and
updating a parameter value of the object linking model based on the training objective function.

12. The device of claim 11, wherein determining the first linking score comprises:
obtaining the supervision information for the target semantic object indicating whether the target semantic object is mentioned in the first text sequence;
in accordance with a determination that the supervision information for the target semantic object indicates that the target semantic object is mentioned in the first text sequence, calculating the first linking score based on the first confidence difference; and
in accordance with a determination that the supervision information for the target semantic object indicates that the target semantic object is not mentioned in the first text sequence, determining the first linking score to indicate that the target semantic object is not linked to the first text element.

13. The device of claim 9, wherein training the object linking model comprises:
determining a third confidence score of the target semantic object being mentioned in the first text sequence with a second text element ignored from the first text sequence; and
training the object linking model further based on a second confidence difference between the first confidence score and the third confidence score.

14. The device of claim 13, wherein training the object linking model further based on the second confidence difference comprises:
determining a third linking score for the second text element based on the second confidence difference, the third linking score indicating a probability of the target semantic object being linked to the second text element;
determining, using the object linking model, a fourth linking score for the second text element based on the first text sequence and the target semantic object, the fourth linking score indicating a probability of the target semantic object being linked to the second text element;
constructing a training objective function for the object linking model based on the third and fourth linking scores, the training objective function being based on an increase of a combined score of the third and fourth linking scores; and
updating a parameter value of the object linking model based on the training objective function.

15. A computer program product being tangibly stored in a computer storage medium and comprising computer-executable instructions, the computer-executable instructions, when executed by a device, causing the device to perform acts comprising:
obtaining a target semantic object and a first text sequence in a natural language, the first text sequence comprising a plurality of text elements;
determining a first confidence score of the target semantic object being mentioned in the first text sequence;
determining a second confidence score of the target semantic object being mentioned in the first text sequence with a first text element being ignored from the first text sequence; and
training an object linking model at least based on a first confidence difference between the first confidence score and the second confidence score, the first text sequence, and the target semantic object, the object linking model being configured to determine whether the target semantic object is linked to one of the plurality of text elements.
